(19) United States
(12) Patent Application Publication
(10) Pub. No.: US 2021/0146400 A1
(43) Pub. Date: May 20, 2021

(54) INTUMESCENT DIRECTED ENERGY PROTECTION

(71) Applicant: The Boeing Company, Chicago, IL (US)

(72) Inventor: Michael Patrick Kozar, Mercer Island, WA (US)

(73) Assignee: The Boeing Company, Chicago, IL (US)

(21) Appl. No.: 16/685,475

(22) Filed: Nov. 15, 2019

(51) Int. Cl. B05D 5/00; B05D 3/06; G01N 17/00

(52) U.S. Cl. CPC B05D 5/00; G01N 17/004; B05D 3/06

(57) ABSTRACT

A method for protecting an underlying structure from directed energy including combining an intumescent material with the underlying structure. The intumescent material forms a barrier to directed energy received on the intumescent material, the barrier suppressing or impeding transmission of the directed energy, and heat generated in the barrier by the directed energy, to the underlying structure.

### BACKGROUND

### 1. Field

Devices including intumescent materials and methods of making the same.

### 2. Description of the Related Art

FIG. 1 illustrates a directed energy source 100 (e.g., a laser source or a microwave source) mounted on a vehicle 102 and used to irradiate a land, sea, or air based target (e.g., an airplane 104) with electromagnetic radiation 106 (e.g., directed energy 108) so as to damage 110 or degrade 112 the target and form a degradation 114. Examples of directed energy 108 include, but are not limited to, laser radiation 116 or microwave radiation. In some cases, the target can be maneuvered or hidden behind a land feature so as to evade the electromagnetic radiation 106. What is needed is a more effective method of protecting the targets from directed energy (e.g., a directed energy attack).

### SUMMARY

The present disclosure describes a method for protecting an underlying structure from directed energy. The method is embodied in many ways including, but not limited to, the following examples.

1. The method comprising combining an intumescent material with the underlying structure, wherein the intumescent material forms a barrier to suppress transmission of the directed energy, and of heat generated in the barrier by the directed energy, to the underlying structure.

2. The method of example 1, wherein the directed energy comprises electromagnetic radiation including microwave radiation, visible radiation, or infrared radiation, the electromagnetic radiation having an intensity greater than 100 milliwatts per centimeter square.

3. The method of example 1, wherein the intumescent material (and/or a gap between the underlying structure and the intumescent material) forms the barrier protecting the underlying structure from a degradation caused by irradiation of the underlying structure with the directed energy in an absence of the barrier, the degradation preventing normal operation of the underlying structure (e.g., device structure).

4. The method of example 3, wherein the intumescent material expands and chars in response to absorbing the directed energy so as to form the barrier comprising an expanded intumescent material including a charred region.

5. The method of example 4, wherein the intumescent material expands in response to the directed energy triggering an ablative burning mechanism wherein:
the heat is generated and consumed so as to form the charred region,
hot gases are formed, the charred region sealing in the hot gases with near zero mass, and
the charred region blocks transfer of the heat to the underlying structure through thermal conduction, convection, and/or radiation.

6. The method of example 1, further comprising combining the intumescent material with a converter material that responds to the directed energy comprising microwave radiation, the converter material converting the microwave radiation to thermal energy absorbed by the intumescent material.

7. The method of example 1, further comprising combining the intumescent material with a reflective layer that reflects the directed energy away from the underlying structure, wherein the intumescent material is activated to protect from a portion of the directed energy that has not been reflected away by the reflective layer.

8. The method of example 1, further comprising combining the intumescent material with a resin, or a fabric (e.g., a non-woven fabric) comprising (e.g., entangled) fibers.

9. The method of example 1, wherein the combining comprises providing one or more particles or one or more fibers including the intumescent material.

10. The method of example 1, wherein the combining comprises coating the intumescent material on the underlying structure.

11. The method of example 1, wherein the combining comprises integrating the intumescent material with the underlying structure so as to form a composite material.

12. The method of example 4, further comprising:
determining the degradation of the underlying structure in response to the directed energy irradiating the underlying structure without the barrier, comprising:
   calculating a decomposition gradient and a thickness of the underlying structure that is degraded by the directed energy; and
   determining a penetration of the directed energy into the underlying structure;
assessing an intumescent behavior of a plurality of different intumescent materials in combination with the underlying structure and the directed energy incident on the different intumescent materials; and
selecting the intumescent material from the plurality of the different intumescent materials, the intumescent material having a composition and thickness such that the expanded intumescent material prevents the degradation.

13. The method of example 12, wherein the assessing comprises at least one of measuring, determining, or obtaining at least one of:
a degree of expansion of the different intumescent materials and a thermal conductivity of the different intumescent materials, in response to the directed energy; and an effectiveness of the different intumescent materials as the barrier for the directed energy.

14. The method of example 13, further comprising determining the thickness of each of the different intumescent materials required for or enabling the different intumescent materials to act as the barrier to the directed energy.

15. The method of example 12, wherein the assessing further comprises determining at least one of a change in a physical property and a chemical property of the intumescent material in response to the directed energy.

16. The method of any of the preceding examples, wherein:
at least one of the intumescent material, or a gap between the intumescent material and the underlying structure, form the barrier preventing a temperature of the underlying structure from increasing by more than a maximum temperature rise in response to the directed energy, wherein:
the maximum temperature rise is given by a degradation temperature minus a pre-irradiation temperature comprising the temperature of the underlying structure prior to the barrier receiving the directed energy, and
the degradation temperature is a glass transition temperature (Tg), a melt temperature, or an ignition temperature of the underlying structure.

The present disclosure further describes a composition of matter for protecting an underlying structure from directed energy. The composition of matter is embodied in many ways including, but not limited to, the following examples.

17. The compositions of matter including a composite material including an intumescent material, wherein the intumescent material forms a barrier to suppress transmission of a directed energy received on the intumescent material, and of heat generated in the barrier by the directed energy, to an underlying structure combined with the intumescent material.

18. The composition of matter of example 17, wherein the composite material includes one or more particles and/or one or more fibers including the intumescent material.

19. The composition of matter of example 17, wherein the composite material comprises a resin, an applique, or a (e.g., woven or non-woven) fabric comprising entangled fibers.

20. The composition of matter of example 19, wherein the (e.g., non-woven) fabric comprises a polymer or a glass.

The present disclosure further describes a device, comprising a component including an intumescent material. The component includes a skin for a vehicle, a structural frame for the vehicle, clothing, armor, an aperture for an optical system, a fuel tank or a fuel conduit in a fuel system, or a housing for electronics. The intumescent material forms a barrier to suppress transmission of directed energy received on the intumescent material, and of heat generated in the barrier by the directed energy, to the component.

### BRIEF DESCRIPTION OF THE DRAWINGS

FIG. 1 illustrates an example directed energy threat and damage that may be caused by the directed energy. Although FIG. 1 illustrates the directed energy source mounted on the vehicle comprising a truck, the vehicle could be an airplane or a boat, for example.

FIG. 2 illustrates a coating comprising intumescent material on a substrate, according to one or more examples described herein.

FIG. 3A illustrates an example composition of matter including the intumescent material and a reflective surface combined with a substrate, wherein the intumescent material is between the substrate and the reflective surface.

FIG. 3B illustrates an example composition of matter including the intumescent material and a reflective surface combined with a substrate, wherein the reflective surface is between the substrate and the intumescent material.

FIG. 3C illustrates an example composition of matter including the intumescent material combined with a converter material for converting microwave radiation to thermal energy.

FIG. 3D illustrates an example composition of matter wherein the converter comprises features embedded in the intumescent material.

FIG. 3E illustrates an example composition of matter wherein the intumescent material is deposited on a structured surface of the converter material.

FIG. 3F-3H illustrate examples including a gap, wherein FIG. 3F illustrates a gap between the intumescent material and a substructure, FIG. 3G illustrates gaps between a reflective layer and the intumescent material and the substructure and the intumescent material, and FIG. 3H illustrates a reflective layer on the intumescent material and a gap between the intumescent material and the substructure.

FIG. 4 illustrates intumescent material combined with a composite material, according to one example.

FIGS. 5A-5E illustrate cross-sections of a particle or a fiber comprising an intumescent material, wherein FIG. 5A illustrates a an example wherein the core of the particle or fiber includes intumescent material, FIG. 5B illustrates an example wherein the cross-section of the particle or fiber is elongate or misshapen, FIG. 5C illustrates an example wherein the particle or fiber has a circular cross section (i.e., the particle is spherical), FIG. 5D illustrates an example wherein the intumescent material comprises a coating on the particle or fiber, and FIG. 5E illustrates a particle with multiple layers comprising a first layer including a core (e.g., comprising carbon, glass, metal, and/or polymer), a second layer including intumescent material 204 on the core; and a third layer (e.g., comprising carbon, glass, metal, and/or polymer) on the intumescent material 204.

FIG. 6A illustrates a fiber having a core including intumescent material and FIG. 6B illustrates a fiber having a cladding including intumescent material, wherein the core is misshapen or geometrical (e.g., the core has a circular cross-section, a polygonal cross-section, or cross-section comprising a complex geometry or shape).

FIG. 6C is a cross-sectional view showing an example composite material including the fiber or particle having a non-uniform or complex shape.

FIG. 6D is an example cross-sectional view through a fiber.

FIG. 6E is a longitudinal cross-sectional view of a fiber , according to another example.

FIG. 6F illustrates an example composite material including fibers embedded in resin, wherein the resin includes intumescent material.

FIG. 6G illustrates an example composite material including intumescent material.

FIG. 6H illustrates an example comprising a substrate including a plurality of grooves that help with holding the intumescent material on the substrate.

FIGS. 7A-7D illustrates response of a coating including intumescent material to directed energy, showing the coating after no exposure to heat (FIG. 7A), 1 second exposure to heat (FIG. 7B), 1 minute exposure to heat (FIG. 7C), and 5 minute exposure to heat (FIG. 7D), wherein the times given are approximate or notional times.

FIG. 8 illustrates response of a composite material including intumescent material, showing formation of char on both sides of the substrate.

FIG. 9 illustrates response of a composite material including intumescent material, showing formation of char and ablation of material from the substrate.

FIG. 10A-10D illustrate example system components or vehicles including intumescent material, showing an electronics system (FIG. 10A), a fuel system (FIG. 10B), a drone (FIG. 10C), and an aperture (FIG. 10D).

FIG. 10E illustrates an exemplary airframe including intumescent material.

FIG. 10F illustrates clothing including body armor and FIG. 10G illustrates body armor including intumescent material.

FIG. 10H illustrates an example building or shelter structure including intumescent material.

FIG. 11 is a flowchart illustrating a method of protecting an underlying (e.g., device structure) using intumescent material.

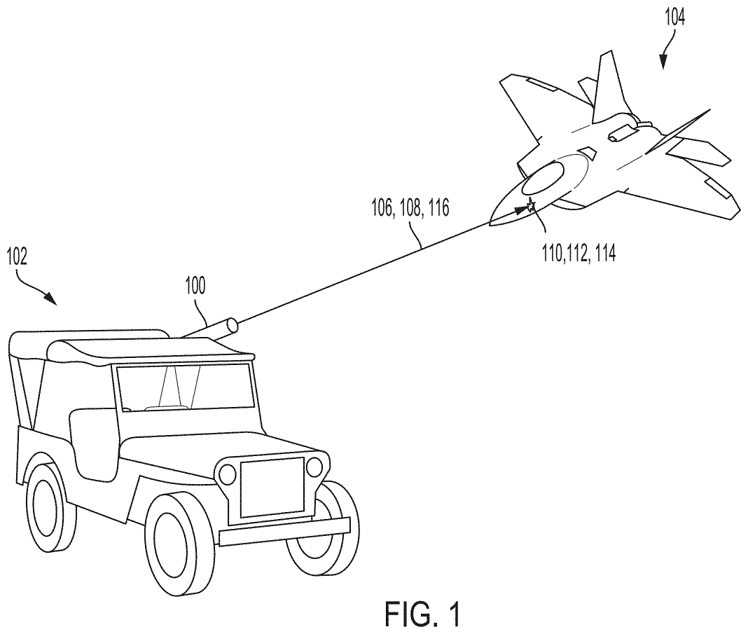

### DESCRIPTION

In the following description, reference is made to the accompanying drawings which form a part hereof, and which is shown, by way of illustration, several examples. It is understood that other examples may be utilized and structural changes may be made without departing from the scope of the present disclosure.

### Technical Description

The present disclosure describes systems and methods using intumescent materials for defensively protecting structures, vehicles, or components from directed energy, e.g., comprising high energy laser radiation or high energy microwave radiation. Certain types of intumescent materials have been applied in paint in buildings or to structural members as a fire-proofing material. Without being bound to a particular scientific theory, intumescence incorporates an ablative burning mechanism wherein heat is consumed via an endothermic char forming reaction while the thermally stable char seals in hot gasses with near zero mass. The char may block out heat transfer via conduction, convection and/or radiation. As a heat shield material including the intumescent material is exposed to a sufficient level of convective or radiative heat transfer, the in-depth thermal gradients induce relative levels of thermochemical decomposition that protect the surface underlying the intumescent material. In one or more examples, a sufficient level of heat transfer comprises the heat transfer resulting from the intumescent material absorbing electromagnetic radiation having an intensity greater than 100 milliwatts (mW) per centimeter square. Although intumescent materials have been used for fire resistance, intumescent materials have not been considered as a means to protect a structure from directed energy (e.g., electromagnetic radiation comprising laser radiation or microwave radiation).

### Example Intumescent Material Configurations

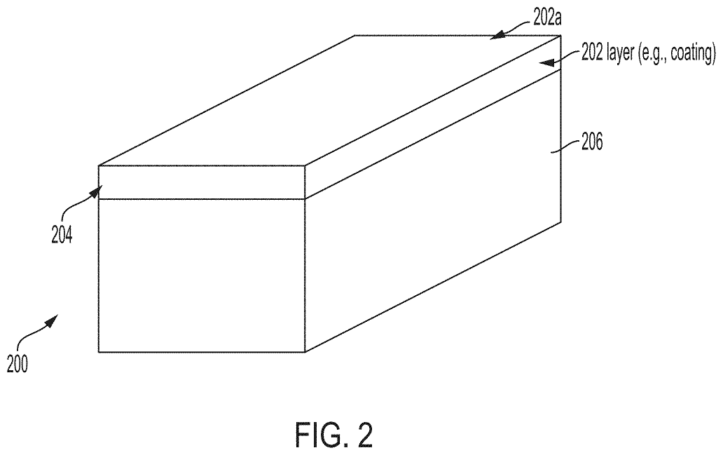

FIG. 2 illustrates a composition of matter 200 comprising a layer 202 (e.g., protection layer) including an intumescent material 204 applied to a substrate 206, e.g., so that the layer comprises a coating that coats a surface of the substrate 206. In various examples, the layer 202 is formulated in a variety of ways to achieve a variety of properties depending on the application. Examples include, but are not limited to, the following.

1. Transparency of the layer 202 can be controlled. In one example, the layer 202 transmits wavelength/frequency band(s) of interest. In another example, the layer 202 is opaque to visible electromagnetic radiation. In another example, the layer is optically transparent.

2. The intumescent material 204 in the layer comprising a topcoat or overcoat, a base coat, a mid-layer, or any combination of the topcoat, base coat, or the mid-layer.

3. The topcoat that is blackened (e.g., to enhance absorption of the directed energy) or mirrored (e.g., to reflect or scatter the directed energy).

4. The intumescent material 204 comprising particles (e.g., spherical or elongated particles) in the layer or coating. In one or more examples, encapsulated particles allow handling or mixing so as to overcome environmental challenges including, but not limited to, moisture, ultraviolet radiation, and airspeed. Example configurations include, but are not limited to, the following.
(i) The particles encapsulated in a thermoplastic resin whose melt temperature is less than the activation energy of the intumescent material and wherein the underlying substrate 206 or object is powder coated.
(ii) The particles encapsulated in thermoset resin (e.g., an epoxy) whose cure temperature is less than the activation energy of the intumescent material or reactive species, e.g., comprising the intumescent material.
(iii) The particles encapsulated in a metal whose processing temperature is less than the activation energy of the intumescent material or reactive species, allowing higher processing temperatures.
(iv) The particles encapsulated in a an inorganic material (e.g., glass, glass ceramic, ceramic) whose processing temperature is less than the activation energy of the intumescent material or reactive species (e.g., comprising the intumescent material).

5. The layer 202 is an applique 202a formulated with or including an adhesive so that the intumescent material can be applied to a substrate 206 and subsequently removed or replaced. In another example, the coating is an applique 202a on a substrate 206 comprising a pressure sensitive adhesive.

6. Any combination of examples 1-5.

### Reflective Material, Gaps, and Converter Material Examples

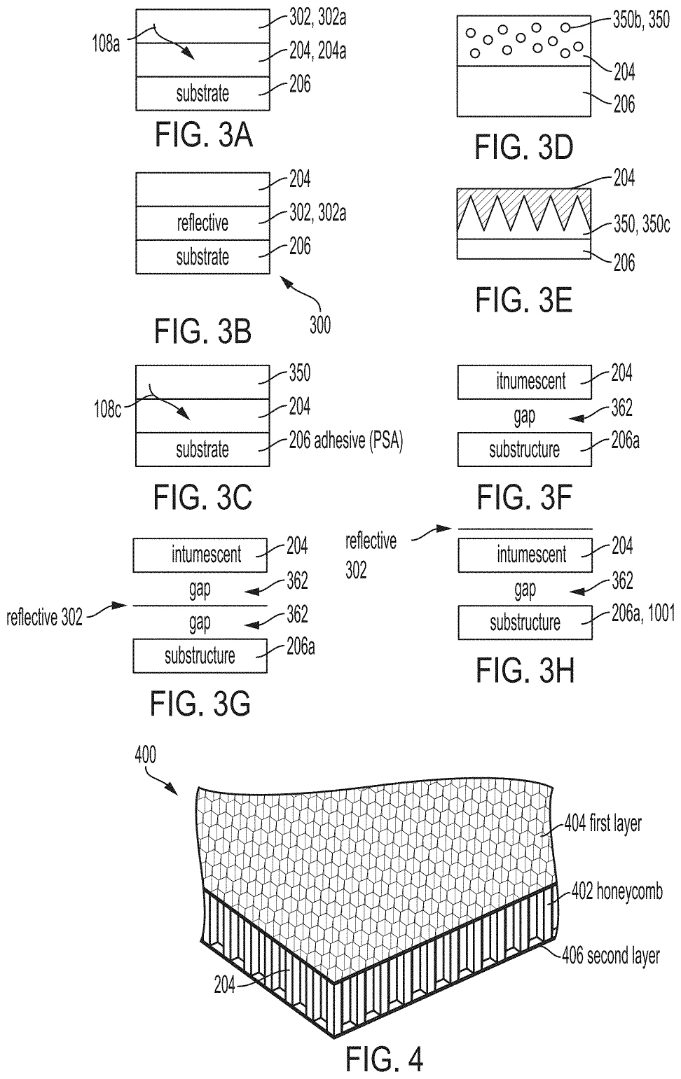

FIG. 3A and FIG. 3B illustrate a composition of matter 300 including an intumescent material 204 combined with a reflective material comprising a reflective layer 302 (having a reflective surface 302a). The reflective layer 302 reflects the directed energy 108 away from the underlying substrate, wherein the intumescent material 204 is activated to protect from a portion 108a of the directed energy 108 that has not been reflected away by the reflective layer 302. Examples include, but are not limited to, the reflective layer having a reflectivity of ≥80%, ≥90%, ≥95%, or ≥98%.

FIG. 3C, FIG. 3D, and FIG. 3E illustrate an example combining the intumescent material 204 with a converter material 350 that responds to the directed energy 108 comprising microwave radiation, the converter material 350 converting the microwave radiation to thermal energy 108c activating the intumescent material 204. FIG. 3D illustrates the converter material 350 comprises features 350b such as, but not limited to, particles, fibers, adjuncts, or other features that screen the intumescent material 204. The features 350b are embedded in the intumescent material 204. FIG. 3E illustrates an example wherein the converter material 350 comprises a structured layer 350c including, for example, grooves, triangular features, or a roughened surface, wherein the structured layer 350c underlies a layer including the intumescent material 204 (e.g., but not limited to, a particle or fiber comprising intumescent material, e.g., a core-sheath nanoparticle).

FIG. 3F and FIG. 3H illustrate examples including a gap 362, wherein FIG. 3F illustrates a gap 362 between the intumescent material 204 and a substrate 206 comprising a sub-structure (e.g., underlying structure 206a), and FIG. 3G illustrates a gap 362 between a reflective layer 302 and the intumescent material 204 and a gap 362 between the sub-structure (underlying structure 206a) and the intumescent material 204. FIG. 3H illustrates a reflective layer 302 on the intumescent material 204 and a gap 362 between the intumescent material 204 and the sub-structure (underlying structure 206a). The gap 362 and/or the intumescent material 204 form a barrier 204a protecting the sub-structure (underlying structure 206a) from, for example, a temperature rise above a predetermined threshold level or a degradation 114 caused by irradiation of the sub-structure (underlying structure 206a) with the directed energy 108 in an absence of the barrier In one or more examples, the degradation prevents normal operation of the underlying structure 206a (e.g., as defined by a manufacturer's specifications for the underlying structure). In one or more examples, the gap 362 comprises an air gap, spacer layer, or thermal insulation layer, or other gap or material providing a thermal break between the protection layer including the intumescent material and the underlying structure being protected. In one or more examples wherein the gap 362 comprises an air gap, a support is provided (e.g., periodically) in the gap or from the edges. Example supports include, but are not limited to, a honeycomb, an egg crate structure, studs, or standoffs, etc.

### Composite Material Examples

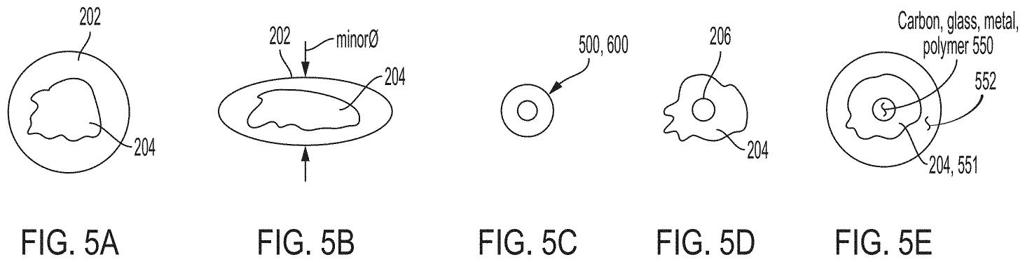

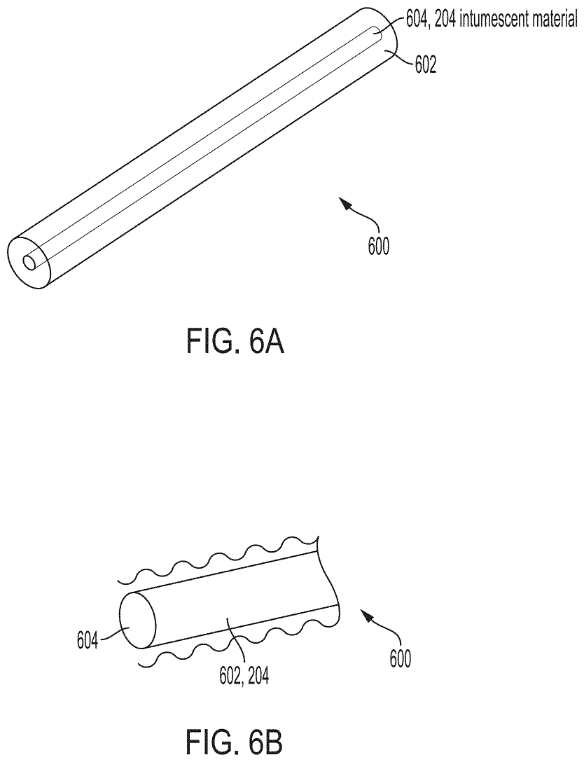

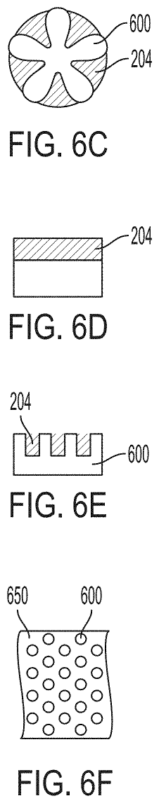

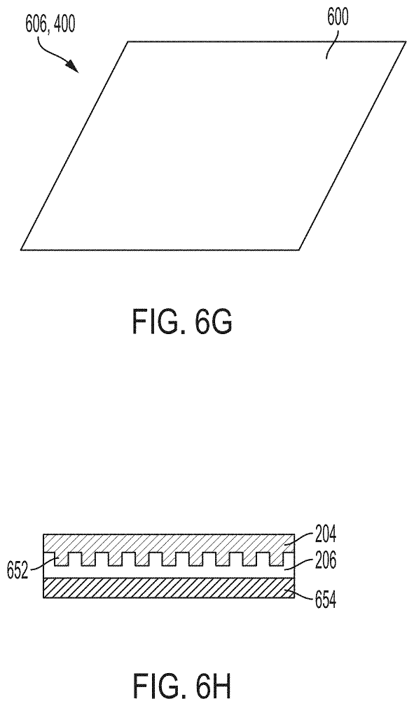

FIG. 4, FIG. 5A, FIG. 5B, FIG. 6A, FIG. 6B, FIG. 6C, FIG. 6D, FIG. 6E, FIG. 6F, and FIG. 6G illustrate the intumescent material 204 disposed in a variety of ways in a composite material 400. As used herein, a composite material 400 is defined as a material including the intumescent material 204 in combination with another material (e.g., chosen for other desirable properties different from intumescent properties). FIG. 4 illustrates the intumescent material 204 comprising a layer within the composite material 400 or a coating on a layer in the composite material. In the example of FIG. 4, the composite material 400 comprises a cellular structure 402 (e.g., honeycomb) sandwiched between a first layer 404 and a second layer 406. The intumescent material 204 is disposed on, or incorporated in the cells of, the cellular structure 402, or applied to the cellular structure 402 as a coating (partial or full coating or partially or totally filling the cells in the cellular structure). In other examples, the intumescent material is incorporated into one or more layers and/or at one or more planar locations of the composite material.

FIGS. 5A-5E illustrates the cross-section of a composition of matter or composite material 400 comprising a particle 500 or fiber 600 (e.g., spherical or elongated particles or fibers) including the intumescent material 204. FIG. 5A illustrates the particle 500 or fiber 600 comprises a layer 202 (e.g., coating) cladding the intumescent material 204. Examples of the layer 202 include, but are not limited to, a polymer, a glass, or a metal. FIG. 5B illustrates the particle can be non-spherical (e.g., elongate) with a major diameter or dimension and a minor diameter or dimension (minor Φ). FIG. 5C and FIG. 5D illustrate examples wherein the particle 500 or fiber 600 includes a layer 202 (e.g., coating) comprising the intumescent material 204 cladding a substrate 206, wherein the substrate 206 comprises a core or lobe including (but not limited to) a glass, a polymer or a metal. FIG. 5E illustrates a particle 500 or fiber 600 with multiple layers comprising a first layer 550 including a core (e.g., comprising carbon, glass, metal, and/or polymer), a second layer 551 including intumescent material 204 on the core; and a third layer 552 (e.g., comprising carbon, glass, metal, and/or polymer) on the intumescent material 204.

FIG. 6A illustrates a fiber 600 including a cladding 602 (e.g., comprising polymer, a metal, or an inorganic material), wherein the cladding clads a substrate 206 comprising a core 604 or lobe (or offset core) comprising the intumescent material 204, e.g., such that the intumescent material 204 is embedded in the material forming the core. FIG. 6B illustrates an example wherein the cladding 602 comprises the intumescent material 204 and the core 604 comprises the polymer, metal, or organic material.

FIGS. 6C illustrates an example wherein the fiber 600 has a complex or non-uniform cross-section. FIG. 6D is a cross sectional view of the fiber in FIG. 6C showing the intumescent material 204 between lobes in a surface of the fiber 600. FIG. 6E is a cross-sectional view showing the intumescent material 204 in channels or grooves on a surface of the fiber 600.

FIG. 6F illustrates an example wherein the fibers 600 are embedded in a resin 650 and the resin 650 includes intumescent material 204.

FIG. 6G illustrates an example wherein the composite material 400 comprises a plurality of the fibers 600 connected together into a fibrous mat, fabric 606 (e.g., woven or non-woven fabric), or composite material 400 is made from unidirectional plies. Examples include the intumescent material 204 disposed in or on the fibers, e.g., as described above, or in the pore spaces between the fibers. In one or more further examples, particles 500 including the intumescent material 204 are dispersed in the fibrous mat, fabric 606 (e.g., woven or non-woven fabric). In yet one or more further examples, the mat, or fabric 606 (e.g., woven or non-woven fabric) comprises a panel. In one or more examples, intumescent material 204 is dispersed in the resin 650 (e.g., wherein the resin is combined with the composite material 400.

FIG. 6H illustrates an example wherein the substrate 206 (on which the intumescent material 204 is deposited) includes a plurality of structures 652 (e.g., grooves or channels) that help with holding the intumescent material 204 on the substrate 206. FIG. 6H shows an example wherein the substrate 206 is on an adhesive 654.

In one or more particle or fiber examples, the particles 500, fibers 600, or intumescent material 204 in the particles or fibers are encapsulated in a thermoplastic whose melt or processing temperature is less than the activation energy of the intumescent material. In one or more further examples, the particles are encapsulated in a thermoset resin whose cure temperature is less than the activation energy of the intumescent material or reactive species comprising the intumescent material, allowing higher processing temperatures.

Examples of fibers 600 include, but are not limited to, filaments and or fibers or filaments disposed in fiber tows. Example materials for the fibers 600, powders, or particles 500 encapsulating or combined with the intumescent material 204 include, but are not limited to materials comprising or consisting essentially of, glass, fused silica, fiberglass, metal, carbon fiber, carbon, boron, metal, mineral and polymer, etc. Examples of the polymers include, but are not limited to, thermoplastics, such as polyamide, polyetherketone (PEK), polyether ether ketone (PEEK), polyetherketoneketone (PEKK), Polyetherimide (PEI), or hybrid forms of thermoplastics as previously mentioned, with modifiers and/or inclusions such as carbon nanotube(s), graphene, clay modifier(s), discontinuous fiber(s), surfactant(s), stabilizer(s), powder(s) and particulate(s). Examples of metallic powders include, but are not limited to, aluminum alloy powders, steel alloy powders, or titanium alloy powders. As used herein, example thermoset resins include, but are not limited to, epoxies, bezoxazines, polyesters, polyimides, and bis-maleimides, etc.). Example dimensions for the fiber and particles include, but are not limited to, diameters, or dimensions in a range of 1 nanometer (nm) to 1000 micrometers. Dimensions include minor and major dimensions (for example, when particles are non-spherical or particles and fibers have non circular cross sections).

In other examples, a material suitable for use as a three-dimensional printing material comprises or is combined with the intumescent material.

In various examples, the areal weight of the protection including the intumescent material (e.g., the composite material 400, e.g., plies, particles 500, or fibers 600 including the intumescent material, or the layer 202 including the intumescent material) is 0.001 pounds per square foot (psf) to10 psf. In one or more aerospace applications, the areal weight is 0.001 psf to 1 psf. In one or more non-aerospace applications (e.g., on a ground vehicle) the areal weight is in a range of 0.010-5 psf.

### Example Operation

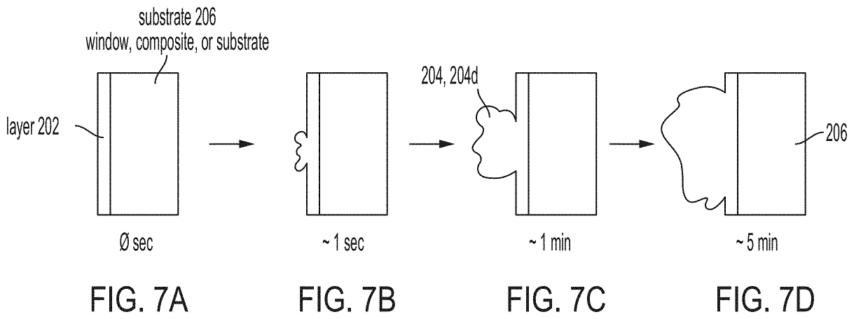

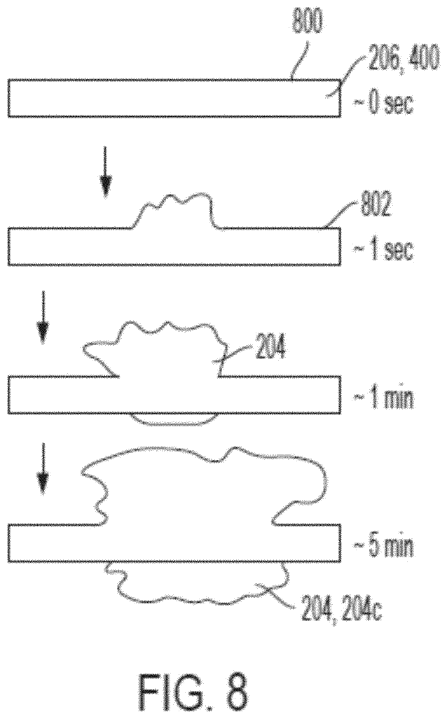

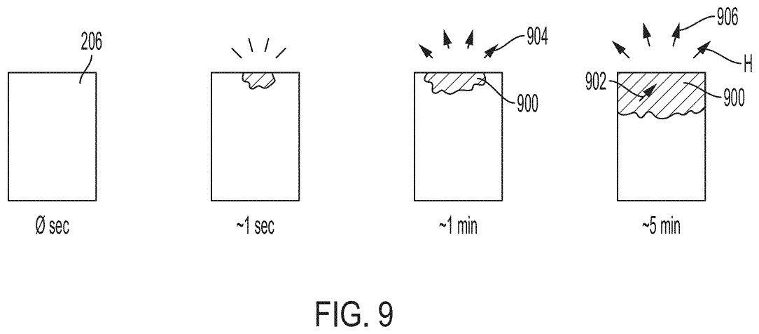

FIG. 7A, FIG. 7B, FIG. 7C, FIG. 7D, FIG. 8, and FIG. 9 illustrate intumescent materials 204 expand (e.g., so as to form expanded intumescent material 204d) and insulate when exposed to a heat source and/or directed energy 108, starting at the weight of the layer 202 (e.g., paint or coating). Also shown are neat regions 800 and activated regions 802 of a composite material 400 including the intumescent material 204. The response of the intumescent material 204 protects the underlying structure 206a from damage including, but not limited to, thermal damage such as convective thermal damage. In one or more examples, the intumescent material 204 forms char comprising a charred region 900 that protects the underlying structure 206a from the damage. In various examples, the formulation of the layer 202 (e.g., coating), intumescent agent in the intumescent material, layer (e.g., coating) thickness, and/or method of application are selected to achieve the required properties that provide the protective properties of the layer 202 or composite material 400 against directed energy 108. By understanding the chemistry of the intumescence of the intumescent material 204, and relating the pyrolysis region expansion of the intumescent material 204 to the decomposition state and the heating rate due to laser radiation or microwave radiation, one can accurately capture the thermodynamic phenomenon and the relative effects on conduction heat transfer, and utilize the properties to protect a structure (e.g., underlying structure 206a) combined with the intumescent material 204. In various examples, different intumescent materials 204c are tested.

FIG. 9 illustrates the intumescent material 204 expands in response to the directed energy 108 triggering an ablative burning mechanism wherein heat (H) is generated and consumed so as to form the char/charred region 900, hot gases 902 are formed, the charred region 900 seals in the hot gases with near zero mass, pieces 904 are ablated from the charred region, and the charred region 900 blocks transfer of the heat (H) to the underlying structure 206a through heat transfer 906 comprising thermal conduction, convection, and/or radiation. In various examples, the intumescent material 204 withstands the directed energy (e.g., having an intensity of ≥100 milliwatts per centimeter square) for target times (e.g., loitering times or illumination times) in a range of 2000 seconds (e.g., 1 second-2000 seconds), 300 seconds (e.g., in a range of 1 second 300 seconds), or 60 seconds (e.g., in a range of 1-60 seconds). In various examples, the intumescent material 204 responds to the directed energy (by expanding and/or forming char) after the target times of in a range of 2000 seconds (e.g., 1 second-2000 seconds), 300 seconds (e.g., in a range of 1 second 300 seconds), or 60 seconds (e.g., in a range of 1-60 seconds).

In one or more examples, the protection layer (e.g., layer 202 or composite material 400) including the intumescent material 204 is designed to prevent the substrate's 206 temperature from increasing above a maximum temperature rise in response to the directed energy 108, wherein the maximum temperature rise is given by the degradation temperature minus the pre-irradiation temperature, and wherein degradation temperature is the temperature at which the underlying substrate 206 degrades in response to the intumescent material. In various examples, the degradation temperature is the glass transition temperature (Tg), melt temperature, the softening temperature, or the ignition temperature of the underlying substrate 206. In one example, for the substrate 206 comprising or consisting essentially of plastic having Tg=200° C. and a pre-illumination temperature of −20° C., the maximum temperature rise is 200−(−20)=220° C. In one or more further examples, the protection layer including the intumescent material 204 is designed to keep the temperature rise 90% of the maximum temperature rise.

### Device Examples

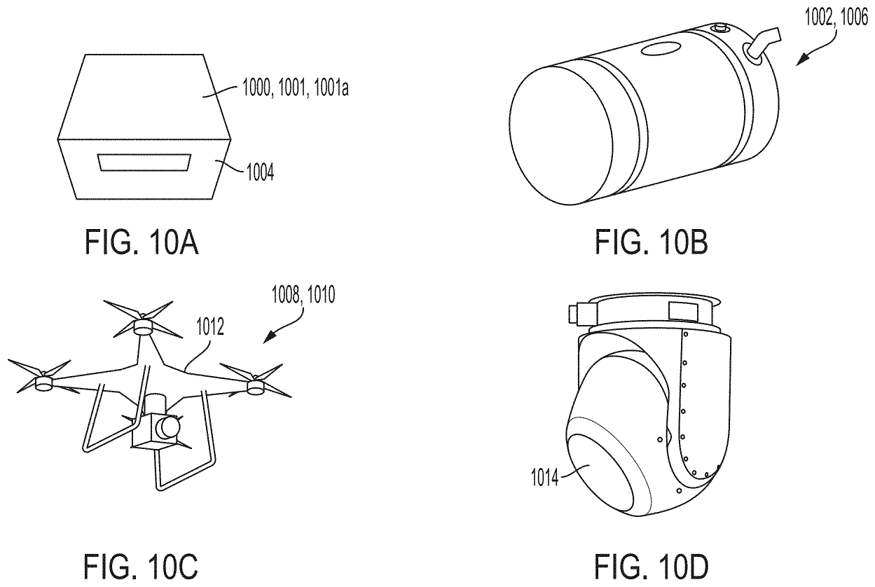

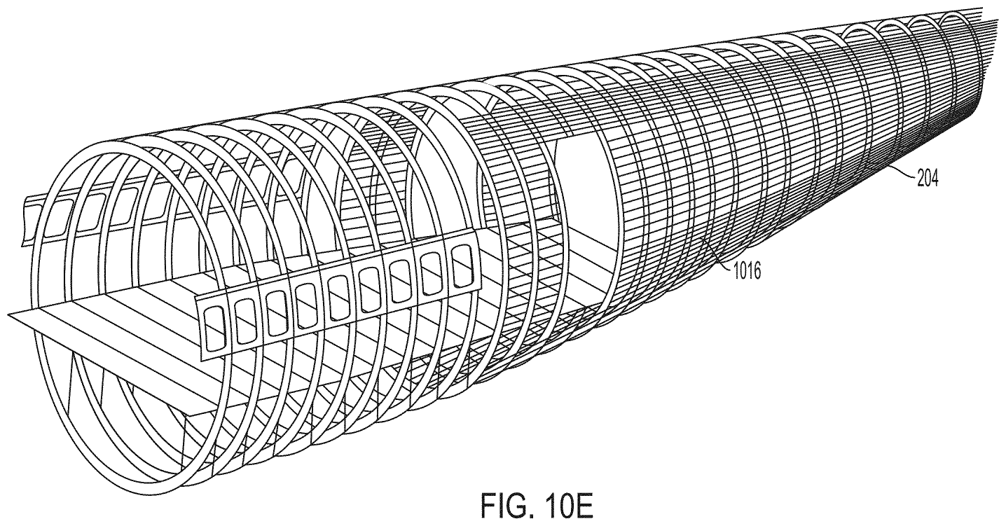

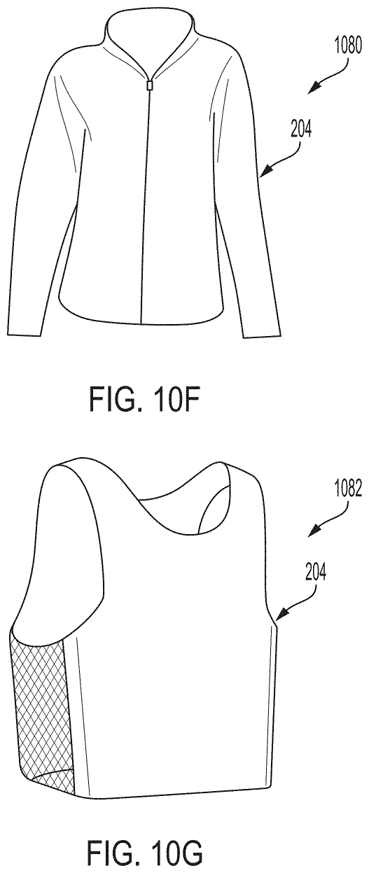

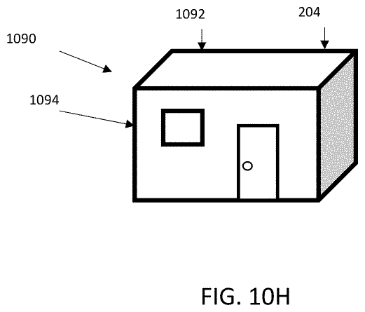

FIGS. 10A-10D illustrate examples wherein the intumescent material 204 is disposed to provide protection of a device 1000, device structure 1001a, underlying structure 1001 (e.g., substrate 206), or a component 1002 of a device 1000 or apparatus. The intumescent material 204 is incorporated using any of the methods described herein (e.g., as a layer 202 (e.g., coating) or as a composite material 400), for example.

Examples include a device 1000 or component 1002 comprising, but not limited to, an electrical system, an optical system, a fuel system, a hydraulic system , or a pneumatic system. In various examples, the intumescent material 204 is provided as a layer 202 (e.g., coating) on the package of the component or on the component itself, or the intumescent material is embedded in materials of the package and/or the component. FIG. 10A illustrates an example wherein the component 1002 comprises a housing 1004 for electronics. FIG. 10B illustrates an example wherein the component 1002 comprises a fuel tank 1006.

FIG. 10C illustrates a vehicle 1008 comprising a drone 1010 comprising an intumescent material 204. In one or more examples, the intumescent material is disposed in a skin 1012 or as a layer 202 (e.g., coating) on the exterior of the drone. In one or more further examples, the intumescent material is disposed to protect only critical components or critical structures of the drone. Examples of critical structures or critical components include, but are not limited to, the airframe of the drone, the transceiver used to remotely control the drone, a computer controlling the drone, and the power source responsible for propelling the drone.

FIG. 10D illustrates an aperture 1014 example. Examples include, but are not limited to, the intumescent material 204 disposed in a layer 202 (e.g., coating) on the aperture 1014 and/or on a housing of the aperture. As described herein, the layer 202 (e.g., coating) may be formulated to be transparent to the wavelength or frequency band of interest being transmitted to a detector behind the aperture.

FIG. 10E illustrates an example structural frame 1016 (e.g., airframe) including the intumescent material 204. The intumescent material is incorporated using any of the methods described herein, for example. Examples include, but are not limited to, the intumescent material 204 disposed as a layer 202 (e.g., coating) on the airframe or in a composite material 400 used in the airframe (e.g., embedded in the structure of the airframe). In one or more examples, the intumescent material 204 is disposed so as to only protect critical structures. Examples of critical structures include, but are not limited to, bulkheads, longerons, stringers, and wing ribs.

FIG. 10F illustrates clothing 1080 (e.g., a jacket, pants, or shirt) including intumescent material 204, e.g., as a layer 202 on the clothing 1080 or as part of the fabric 606 of the clothing 1080 or incorporated using any of the methods described herein. FIG. 10G illustrates body armor 1082 including intumescent material 204, e.g., as a layer 202 on the body armor 1082 or as part of the fabric 606 of the body armor 1082.

FIG. 10H illustrates a building 1090 (e.g., providing shelter) including a component such as, but not limited to, a frame 1092, a wall 1094, a roof, a window, a door, or other structural member including intumescent material 204. In various examples, the intumescent material is incorporated using any of the methods described herein. In various examples, the intumescent material is comprises a layer 202 on the component or the component comprises (or is integrated with) the intumescent material (e.g., the component includes a composite material 400).

### Process Steps

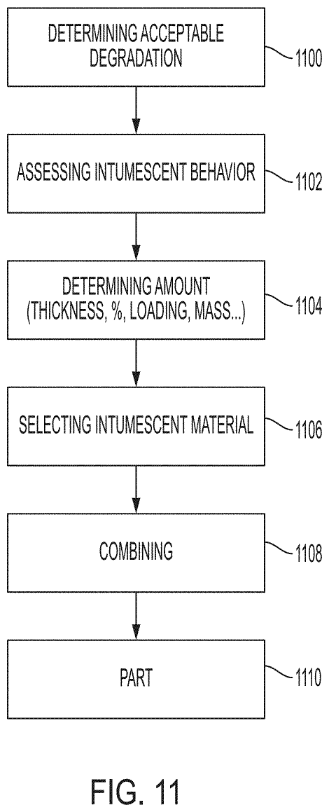

FIG. 11 illustrates a method for protecting a device structure 1001a (e.g., underlying structure or substrate 206) from directed energy 108.

The method comprises the following steps.

Block 1100 represents determining the degradation of a device structure e.g., vehicle, armor, clothing, or component or composite material, in response to the directed energy irradiating the device structure without a protective barrier. The determining comprises calculating a loiter time and a decomposition gradient and a thickness of the device structure that is degraded by the directed energy; and determining a penetration of the directed energy into the device structure.

Block 1102 represents assessing an intumescent behavior of a plurality of different intumescent materials in combination with the device structure and the directed energy incident on the different intumescent materials. In one or more examples, the assessing comprises measuring, determining, or obtaining a degree of expansion of the different intumescent materials and a thermal conductivity of the different intumescent materials, in response to the directed energy; and/or an effectiveness of the different intumescent materials as a protective barrier against the directed energy. In one or more further examples, the assessing further comprises determining a change in a physical property and/or a chemical property of the intumescent material in response to the directed energy.

Block 1104 represents determining an amount (e.g., the thickness, percentage, loading, mass) of each of the different intumescent materials required for the different intumescent materials to act as the barrier to the directed energy.

Block 1106 represents selecting the intumescent material 204 from the plurality of the different intumescent materials, the intumescent material having a composition and thickness such that the expanded intumescent material prevents the degradation 114.

Block 1108 represents combining the intumescent material with the device structure, the underlying structure, or in a composite material, wherein the intumescent material forms a barrier to suppress transmission of the directed energy received on the intumescent material, and of heat generated in the barrier by the directed energy, to the device structure, the underlying structure, or the composite material.

Block 1110 represents the end result, a composition of matter or device or part including the intumescent material. The device, device structure (e.g., underlying structure), composition of matter, or method is embodied in many ways including, but not limited to, the following.

1. A composition of matter (200, 300) for protecting an underlying structure (1001) from directed energy (108), comprising a composite material (400) including an intumescent material (204), wherein the intumescent material (204) forms a barrier (204a) to directed energy (108) received on the intumescent material (204), the barrier (204a) suppressing transmission of the directed energy (108), and heat (H) generated by the directed energy (108), to an underlying structure (1001) combined with the intumescent material (204).

2. A device (1000), comprising a component (1002) or vehicle (1008) including an intumescent material (204), the component (1002) comprising a skin (1012) for a vehicle (1008), a structural frame for the vehicle (1008), an aperture (1014) or transparent window for an optical system, a fuel tank (1006) or a fuel conduit in a fuel system, or a housing (1004) for electronics; an electronic circuit, a computer, a communications device (1000) (e.g., cellular phone), armor, or clothing, wherein the intumescent material (204) forms a barrier (204a) to suppress transmission of directed energy (108) received on the intumescent material (204), the barrier (204a) suppressing or impeding transmission of the directed energy (108), and heat (H) generated by the directed energy (108), to the component (1002) or vehicle (1008).

3. The method or device (1000) or composition of matter of any of the clauses 1-2, wherein the directed energy (108) comprises electromagnetic radiation (106) (e.g., laser radiation) including microwave radiation, radio frequency radiation or infrared radiation (e.g., near infrared radiation), the electromagnetic radiation (106) having an intensity greater than 100 milliwatts per centimeter square or in a range of 100 milliwatts per centimeter square to 1 megawatt per centimeter square.

4. The method or device (1000) or composition of matter of any of the clauses 1-3, wherein the intumescent material (204) forms the barrier (204a) protecting the underlying structure (1001) from a degradation 114 (e.g., thermal damage) caused by irradiation of the underlying structure (1001) with the directed energy (108) in an absence of the barrier (204a), the degradation preventing normal operation of the underlying structure (1001). In one or more examples, normal operation includes performance characteristics defined in a data sheet , manufacturer's specifications, or user's manual (e.g., flight manual, operation handbook, or instruction manual) . In one example, the underlying structure comprises an airframe of an aircraft and the degradation preventing normal operation of the airframe comprises a breach or break of the airframe forcing the aircraft to perform an emergency landing. In another example, the underlying structure includes a housing for electronics and the degradation prevents operation of the electronics according to specifications in a data sheet or the user manual for the electronics. In yet another example, the underlying structure includes a fuel tank and the degradation comprises a hole in the fuel tank allowing fuel to leak out of the fuel tank. In yet another example, the underlying structure comprises an aperture and the degradation prevents operation of a detector behind the aperture according to performance specifications in a data sheet or user manual for the detector. In yet another example, the underlying structure comprises human skin and the degradation comprises a burn on the skin.

5. The method or device (1000) or composition of matter of any of the clauses 1-4, wherein the intumescent material (204) expands or grows and chars in response to absorbing the directed energy (108) so as to form the barrier (204a) comprising an expanded intumescent material (204c) including a charred region (900).

6. The method or device (1000) or composition of matter of the clause 5, wherein the intumescent material (204) expands in response to the directed energy (108) triggering an ablative burning mechanism wherein:
heat (H) is generated and consumed so as to form the charred region (900),
hot gases are formed, the charred region (900) sealing in the hot gases with near zero mass, and
the charred region (900) blocks transfer of the heat (H) to the underlying structure (1001) through thermal conduction, convection, and/or radiation.

7. The method or device (1000) or composition of matter of any of the clauses 1-6, wherein, in response to the directed energy, the intumescent material (204) grows or expands to a thickness in a range of 0.5 millimeters (mm) to 10 mm and/or the intumescent material grows or expands to a thickness 1 times (×) to 100×the original thickness of the intumescent material, wherein the original thickness is the thickness of the intumescent material before receiving the directed energy.

8. The method or device (1000) or composition of matter of any of the clauses 1-7, wherein the intumescent material (204) is combined with a resin (650), thermoplastic, thermoset resin, a fabric (606) (e.g., woven or non-woven fabric) comprising fibers (600) (e.g., entangled fibers). Example combination methods include embedding or sprinkling the intumescent material (204) in the resin (650) or in the composite material (400) (e.g., the non-woven or woven fabric).

9. The method or device (1000) or composition of matter of clause 8, wherein the fabric (606) comprises a polymer.

10. The method of any of the above examples, wherein the combining comprises coating (202) the intumescent material (204) as a layer (202) (e.g., coating) on the underlying structure (1001). Example coating methods include, but are not limited to, spray coating, ink jet printing, and powder coating.

11. The method of any of the above described examples, wherein the combining comprises integrating the intumescent material (204) with the underlying structure (1001) so as to form a composite material (400). In one or more examples, the intumescent material (204) is intermingled with or sprinkled throughout, or embedded in fibers (600) or particles (500) in the composite material (400).

12. The method or device (1000) or composition of matter of any of the clauses 1-11, wherein the intumescent material (204) comprises a carbonization agent, an acid source, a blowing agent; and a binder binding the carbonization agent, the acid source, and the blowing agent.

13. A lightweight protection system comprising the composition of matter (200, 300) of any of the clauses 1-12, incorporated or included as a component (1002) of an asset (e.g., mortar, aircraft, or missile) so that the asset can operate unencumbered for a predetermined amount of time.

14. The method or device (1000) or composition of matter (200, 300) of any of the clauses 1-13, further comprising an absorbing, heat (H) generating material or component (e.g., converter material 350) placed on and/or within the intumescent material (204) to facilitate interaction/absorption of the directed energy (108) comprising microwave radiation, e.g., so that the intumescent material (204) responds more quickly to the directed energy (108).

15. The method or device (1000) or composition of matter of clause 14, including an overcoat having a black color that enhances absorption of the directed energy (108).

16. The method or device (1000) or composition of matter of clause 14, wherein the component (e.g., converter material 350) responds to microwave radiation, e.g., by absorbing/converting the microwave radiation to thermal energy (108).

17. The method or device (1000) composition of matter of any of the clauses 1-16, further comprising a reflective or scattering surface (e.g., reflective layer 302) that reflects (e.g., through specular reflection) the directed energy (108) away from the underlying structure (1001) (e.g., in all directions). In one example, the intumescent material (204) is positioned between the reflective layer (302) and the underlying structure (1001) so that the intumescent material (204) is activated to protect from any residual directed energy (108) that has not been scattered or reflected away by the reflective layer 302 comprising a reflective or scattering surface.

18. The method or device (1000) or composition of matter of any of the clauses 1-17, further comprising the intumescent material (204) combined with a material having a polished outside surface surrounding or forming a layer (202) (e.g., coating) the intumescent material (204), comprising a particle (500) wherein the intumescent material (204) is inside the polished outside surface of the particle, and optionally covering the polished surface with an epoxy.

19. The method or device (1000) composition of matter of any of the clauses 1-18, wherein the intumescent material (204) is embedded or encapsulated within a composite material (400) so that the intumescent material (204) remains intact and is prevented from disengaging or shedding away in an airstream, and/or so as to prevent degradation of the intumescent material (204) in, or exposure of the intumescent material to, a wet environment.

20. The method or device or composition of matter of any of the clauses 1-19, wherein the intumescent material (204) is combined with a frame (e.g., airframe) or skin or coating or wall of a component, system, or vehicle. In one or more examples, the intumescent material is only combined with critical structural elements of the frame (e.g., bulkheads) that are required for structural integrity to prevent disintegration of the vehicle or component or system (e.g., the intumescent material is combined with a monocoque or semi-monocoque structure).

21. The method or device or composition of matter of any of the clauses 1-20, wherein the intumescent material is combined with a non-structural (e.g., low strength) structure, such as a fairing, a shroud, or an electronic box, for example.

23. The method or device or composition of matter of any of the clauses 1-21, wherein the intumescent material also provides fire protection.

24. The method or device or composition of matter of any of the clauses 1-23, further comprising an adhesive (654) (e.g., pressure sensitive adhesive or adhesive backing) including or combined with the intumescent material (204) so that the intumescent material is attachable to a variety of device structures or underlying structures, e.g., as a retrofit. In one or more examples, the adhesive comprises a peel and stick layer that can be peeled from and stuck onto surfaces.

25. The method or device or composition of matter of any of the clauses 1-24, wherein the composition of matter is configured to be retrofittable and/or repairable.

26. The method or device or composition of matter of any of the clauses 1-25, wherein the composition of matter is configured to be a permanent or a temporary fixture on the device structure or the underlying structure.

27. The method or device or composition of matter of any of the clauses 1-26, wherein the intumescent material (204) is combined with a layer (202) comprising a transparent layer so as to form an engineered protective coating that reacts but does not interfere with transmission of signals to the underlying structure (e.g., device structure). In one or more examples, the activated intumescent material may be visibly opaque but a detector underneath still functions because the signal (e.g., radio frequency) is transmitted through charred material in the charred region (900).

28. The method or device or composition of matter of any of the clauses 1-27, wherein a thickness, composition, or amount of the intumescent material is tailored for an application. In one or more examples, the intumescent material or layer (202) (e.g., coating) has a thinner thickness sufficiently thick to protect the underlying structure (1001) (e.g., device structure) from the directed energy 108 for a period of time needed to maneuver or roll the underling structure (e.g., vehicle (1008) or aircraft such as an airplane (104)) out of the path of the directed energy 108.

29. The method or device or composition of matter of any of the clauses 1-28, wherein the intumescent material (204) is a particle (500) embedded in a low temperature melt material having a melt temperature lower than an activation temperature of the intumescent material (activation temperature is the temperature at which the intumescent material expands and chars in response to the directed energy).

30. The method or device or composition of matter of any of the clauses 1-29, wherein the intumescent material comprises or consists essentially of (but is not limited to), carbohydrates with sodium bicarbonate, ammonium polyphosphate, sodium silicate/graphite, borax, sodium metasilicate, ammonium phosphate, aluminum sulfate hexadecahydrate, inert filler (powdered silica), Glauber's salt, intumescent salt, borax/sodium metasilicate, zinc metaborate, and aluminum hydroxide.

31. The method or device or composition of matter of any of the clauses 1-30, wherein the composite material (400) or layer (202) including the intumescent material has an areal weight in a range of 0.01-0.05 pounds per square foot. In one or more aerospace applications, the areal weight is 0.001 psf to 1 psf. In one or more non-aerospace applications (e.g., on a ground vehicle) the areal weight is in a range of 0.010-5 psf.

32. The method of any of the preceding examples, further comprising:
determining the degradation of the underlying structure (1001) in response to the directed energy (108) irradiating the underlying structure (1001) without the barrier (204a), comprising:
   calculating a decomposition gradient and a thickness of the underlying structure (1001) that is degraded by the directed energy (108); and
   determining a penetration of the directed energy (108) into the underlying structure (1001);
assessing an intumescent behavior of a plurality of different intumescent materials (204c) in combination with the underlying structure (1001) and the directed energy (108) incident on the different intumescent materials (204c); and
selecting the intumescent material (204) from the plurality of the different intumescent materials (204c), the intumescent material (204) having a composition and thickness such that the expanded intumescent material (204d) prevents the degradation (114).

33. The method of example 32, wherein the assessing comprises at least one of measuring, determining, or obtaining:
a degree of expansion of the different intumescent materials (204c) and a thermal conductivity of the different intumescent materials (204c), in response to the directed energy; and/or
an effectiveness of the different intumescent materials (204c) as the barrier (204a) for the directed energy (108).

34. The method of example 33, further comprising determining the thickness of each of the different intumescent materials (204c) enabling the different intumescent materials (204c) to act as the barrier (204a) to the directed energy (108).

35. The method of example 33, wherein the assessing further comprises determining a change in a physical property and/or a chemical property of the intumescent material (204) in response to the directed energy (108).

36. The composition of matter, device, or method of any of the preceding examples, wherein the composite material (400) includes one or more particles (500) or one or more fibers (600) including the intumescent material (204).

37. The composition of matter, device, or method of any of the preceding examples, wherein the composite material (400) comprises a resin (650), an applique (202a), or a fabric (606) (e.g., woven or non-woven fabric) comprising fibers (600) (e.g., entangled fibers).

38. The composition of matter, device, or method of any of the preceding examples, wherein the fabric (606) (e.g., woven or non-woven fabric) comprises a polymer or glass.

39. The method, composition of matter, or device of any of the preceding examples, further comprising combining the intumescent material (204) with a reflective layer (302) that reflects the directed energy (108) away from the underlying structure (1001).

40. The method, composition of matter, or device of any of the preceding examples, wherein the intumescent material (204) is positioned between the reflective layer (302) and the underlying structure (1001) such that the intumescent material (204) is activated to protect from a portion (108a) of the directed energy (108) that has not been reflected away by the reflective layer (302).

41. The method, composition of matter, or device of any of the preceding examples, wherein a protection layer (e.g., layer (202) or composite material (400)) including the intumescent material is designed to prevent the substrate temperature of the underlying structure (1001) or substrate (206) from increasing above a maximum temperature rise in response to the directed energy (108), wherein the maximum temperature rise is given by the degradation temperature minus the pre-irradiation temperature, wherein degradation temperature is the temperature at which the underlying substrate 206 or underlying structure (1001) degrades in response to the directed energy (108). In various examples, the degradation temperature is the glass transition temperature (Tg), melt temperature, the softening temperature, or the ignition temperature of the underlying substrate (206) or the underlying structure (1001). In one example, for the substrate 206 or the underlying structure (1001) comprising or consisting essentially of plastic having Tg=200° C. and a pre-illumination temperature of −20° C., the maximum temperature rise is 200−(−20)=220° C. In one or more further examples, the protection layer (e.g., layer (202) (or composite material (400)) including the intumescent material is designed to keep the temperature rise 90% of the maximum temperature rise. In one or more examples, melt temperature is the temperature at which the underlying structure changes from a solid to liquid state. In one or more examples, the softening temperature is the temperature at which the underlying structure softens beyond some predetermined softness, e.g., determined, for example, by the Vicat method (ASTM-D1525 or ISO 306), Heat Deflection Test (ASTM-D648) or a ring and ball method (ISO 4625or ASTM E28-67/E28-99 or ASTM D36 or ASTM D6493 11). In one or more further examples, ignition temperature is the lowest temperature at which the underlying substrate spontaneously ignites in normal atmosphere without an external source of ignition, such as a flame or spark (e.g., the temperature required to supply the activation energy needed for combustion).

42. The method, composition of matter, or device of any of the preceding examples, wherein the areal weight of the protection including the intumescent material (e.g., a composite material (400), e.g., plies, fabric (606), particles (500), fibers (600)) including the intumescent material, or the layer (202) including the intumescent material) is 0.001 pounds per square foot (psf) to10 psf. In one or more aerospace applications, the areal weight is 0.001 psf to 1 psf. In one or more non-aerospace applications (e.g., on a ground vehicle) the areal weight is in a range of 0.010-5 psf.

43. The method, composition of matter, or device of any of the preceding examples, including a gap (362) between the intumescent material (204) and the underlying structure (1001), the gap comprises an air gap, spacer layer, or insulation layer, or other gap providing a thermal break between the protection layer including the intumescent material and the underlying structure being protected.

### Conclusion

This concludes the description of the examples of the present disclosure. The foregoing description of the examples has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method for protecting an underlying structure from a directed energy, the method comprising:
combining an intumescent material with the underlying structure, wherein the intumescent material forms a barrier to suppress transmission of the directed energy, and of heat generated in the barrier by the directed energy, to the underlying structure.

2. The method of claim 1, wherein the directed energy comprises electromagnetic radiation including microwave radiation or infrared radiation, the electromagnetic radiation having an intensity of greater than 100 milliwatts per centimeter square.

3. The method of claim 1, wherein:
at least one of the intumescent material, or a gap between the intumescent material and the underlying structure, form the barrier preventing a temperature of the underlying structure from increasing by more than a maximum temperature rise in response to the directed energy, wherein:
the maximum temperature rise is given by the degradation temperature minus a pre-irradiation temperature comprising the temperature of the underlying structure prior to the barrier receiving the directed energy, and
the degradation temperature is a glass transition temperature (Tg), a melt temperature, a softening temperature, or an ignition temperature of the underlying structure.

4. The method of claim 3, wherein the intumescent material expands and chars in response to absorbing the directed energy so as to form the barrier comprising an expanded intumescent material including a charred region.

5. The method of claim 4, further comprising:
determining the degradation of the underlying structure in response to the directed energy irradiating the underlying structure without the barrier, comprising:
calculating a decomposition gradient and a thickness of the underlying structure that is degraded by the directed energy; and
determining a penetration of the directed energy into the underlying structure;
assessing an intumescent behavior of a plurality of different intumescent materials in combination with the underlying structure and the directed energy incident on the plurality of different intumescent materials; and
selecting the intumescent material from the plurality of different intumescent materials, the intumescent material having a composition and a thickness such that the expanded intumescent material prevents the degradation.

6. The method of claim 5, wherein the assessing comprises at least one of measuring, determining, or obtaining:
a degree of expansion of the plurality of different intumescent materials and a thermal conductivity of the plurality of different intumescent materials, in response to the directed energy; or
an effectiveness of the plurality of different intumescent materials as the barrier to the directed energy.

7. The method of claim 6, wherein the assessing further comprises determining a change in at least one of a physical property or a chemical property of the plurality of different intumescent materials in response to the directed energy.

8. The method of claim 1, further comprising combining the intumescent material with a converter material that responds to the directed energy comprising microwave radiation, the converter material converting the microwave radiation to thermal energy activating the intumescent material.

9. The method of claim 1, further comprising combining the intumescent material with a reflective layer that reflects the directed energy away from the underlying structure.

10. The method of claim 9, wherein the intumescent material is positioned between the reflective layer and the underlying structure such that the intumescent material is activated to protect from a portion of the directed energy that has not been reflected away by the reflective layer.

11. The method of claim 9, further comprising a gap between the reflective layer and the intumescent material, wherein the gap provides a thermal break between the intumescent material and the underlying structure.

12. The method of claim 1, further comprising combining the intumescent material with a resin or a fabric comprising fibers.

13. The method of claim 1, wherein the combining comprises providing one or more particles or one or more fibers including the intumescent material.

14. The method of claim 1, wherein the combining comprises coating the intumescent material on the underlying structure.

15. The method of claim 1, wherein the combining comprises integrating the intumescent material with the underlying structure so as to form a composite material.

16. A composition of matter for protecting an underlying structure from a directed energy, comprising:
a composite material including an intumescent material, wherein the intumescent material forms a barrier to suppress transmission of the directed energy, and of heat generated in the barrier by the directed energy, to the underlying structure combined with the intumescent material.

17. The composition of matter of claim 16, wherein the composite material includes particles or fibers including the intumescent material.

18. The composition of matter of claim 17, wherein the composite material comprises a resin, an applique, or a fabric comprising fibers.

19. The composition of matter of claim 18, wherein the fabric comprises a polymer or a glass.

20. A device, comprising:
a component including an intumescent material, the component comprising:
a skin for a vehicle,
a structural frame for the vehicle,
an aperture for an optical system,
a fuel tank or a fuel conduit in a fuel system,
a housing for electronics,
clothing, or
armor;
wherein the intumescent material forms a barrier to suppress transmission of a directed energy, and of heat generated in the barrier by the directed energy, to the component.
